(19) United States
(12) Patent Application Publication
(10) Pub. No.: US 2007/0258712 A1
(43) Pub. Date: Nov. 8, 2007

(54) Method and apparatus for the vaporous development of photoresist

(76) Inventor: William A. Moffat, San Jose, CA (US)

Correspondence Address: MICHAEL A. GUTH, 2-2905 EAST CLIFF DRIVE, SANTA CRUZ, CA, 95062, US

(21) Appl. No.: 11/416,810

(22) Filed: May 3, 2006

(51) Int. Cl. G03B 17/02

(52) U.S. Cl. 396/536

(57) ABSTRACT

An apparatus and method for the development of photoresist utilizing vaporized developer. The substrate may be cooled such that the vaporized developer condenses on the substrate and in the features developing in the substrate. An ultrasonic vibrator may be used to vibrate the substrate to dispel the condensed vapors in the features.

### BACKGROUND

1. Field of the Invention

The invention relates to positive photoresist, and more specifically to an apparatus and method for the development of positive photoresist using vapor.

2. Description of Related Art

The fabricating of semiconductor devices typically includes a deposition process of forming a target film on a semiconductor substrate, a photolithography process of forming and patterning a photoresist layer of the target film, an etching process of selectively removing the portions of the target film exposed by the photoresist pattern, and a cleaning process of removing the photoresist pattern and the residue resulting from the etching process using a cleaning solution so that only the portion of the target film which was not removed by the etching process is left. The photolithography process entails directing exposure light onto the photoresist layer through a mask of reticle having a pattern that is thereby transcribed onto the photoresist layer, and developing the exposed photoresist layer. As a result, selective portions of the photoresist layer are removed and the remaining portions constitute the photoresist pattern. The critical dimension of the photoresist pattern is dependent upon the energy level of the exposure light emitted onto the photoresist layer through the photomask.

However, as semiconductor devices become more highly integrated, the design rules of the devices become smaller and smaller, i.e., patterns having very small critical dimensions must be formed. These patterns often include a series of contact holes or a series of lines and spaces. Techniques have been developed in photolithography so that a fine pattern can be formed.

The semiconductor substrate having the photoresist film formed thereon is then immersed in a developer solution. At this time, either the exposed portion of the photoresist is removed by the developer solution (positive type of photoresist) or the non-exposed portion is removed by the developer solution (negative type of photoresist). Accordingly, the photoresist is patterned. The photoresist pattern will serve as an etch mask for the formation of lines or contact holes in a portion of the underlying layer located on the substrate.

With the reduction of size in features in the photoresist film, another problem may occur. The developer solution may have difficulty working its way into the small scale features as they begin to form in the photoresist layer. This may be caused by the surface tension of the developer solution and by other causes. In addition, the use of solution developer can be costly, especially as a substrate is repeatedly layered and the photoresist process is repeated.

What is needed is a method of developing photoresist that is compatible with the small features of modern photoresist patterns, as well as a less costly method of developing photoresist.

### SUMMARY

An apparatus and method for the development of photoresist utilizing a vaporized developer. The substrate may be cooled such that the vaporized developer condenses on the substrate and in the features developing in the substrate. An ultrasonic vibrator may be used to vibrate the substrate to enhance the process and to dispel the condensed vapors in the features.

### BRIEF DESCRIPTION OF THE DRAWINGS

FIG. 1A is a sketch of a substrate with a photoresist layer.

FIG. 1B is a sketch of a substrate with a photoresist layer with features in various stages of development.

FIG. 2A is a sketch of a substrate with a photoresist layer with finer features being developed.

FIG. 2B is a sketch of a substrate with t a photoresist layer with finer features being developed showing process difficulties.

FIG. 3 is a sketch of a photoresist developing apparatus according to some embodiments of the present invention.

FIG. 4 is a sketch of a partial view of photoresist developing apparatus according to some embodiments of the present invention.

### DETAILED DESCRIPTION

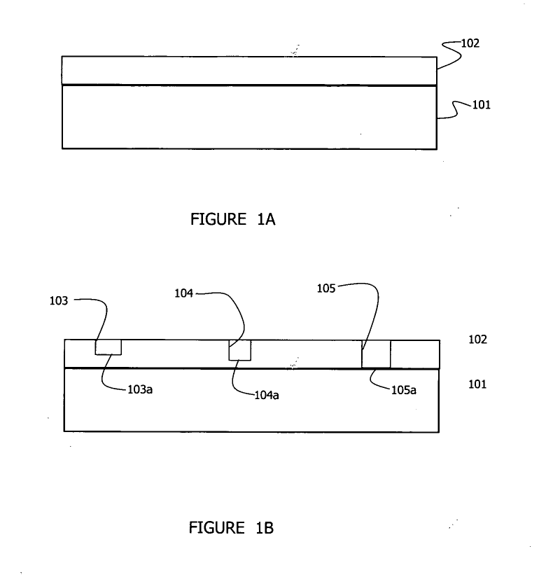

FIG. 1A is a sketch of a substrate 101 with an applied layer 102 of positive photoresist. Typically, prior to application, positive photoresist consists of three constituents. The first constituent is alcohols, and may be approximately 10% of the solution. The second constituent is the photosensitive constituent, such as a diazo-quinone, which may be approximately 40% of the solution. The third constituent is polymers, which may be approximately 50% of the solution. The diazo-quinone portion is sensitive to ultraviolet light and heat above 90 C. When exposed to light, the diazo-quinone breaks down into indene-carbo-oxylic acid. Because of the sensitivity of this constituent to ultraviolet light, which is present in normal light, the processing of the photoresist is typically done in a light that does not have an ultraviolet component. Other photoresist compositions may be used in accordance with this invention, and the photoresist chemical compositions above are used for example.

The photoresist layer is typically applied to a wafer in a layer on the order of 10,000 Angstroms thick. The applied layer may then be heated to 90 C for 30 minutes to drive out a significant portion of the alcohol resulting in a consistent gel layer on the wafer. The photoresist layer is then exposed to ultraviolet light in a pattern desired by the user, typically using a glass mask. The areas below the holes in the mask are exposed to the ultraviolet light and break down into the acid. Washing this layer with a light basic solution will eat the acid areas relatively quickly, perhaps in 60 seconds. In this same time, the unexposed areas will be attacked by the basic solution but to a much lesser extent, perhaps 10%. This basic solution is the developer solution for the photoresist layer, and tetra-methyl-ammonium-hydroxide (TMAH) is widely used for this purpose.

FIG. 1B illustrates the development process of a photoresist layer. A first hole 103 is shown at a first, earlier time in the development process and the bottom 103a of the hole 103 is seen part way down into the photoresist layer 102. A second hole 104 is used to illustrate the process at a slightly later time in the process, and one can see that the bottom 104a of the hole 104 is further down into the photoresist layer 102. A third hole 105 is used to illustrate the process at an even later time, and one can see that the bottom 105a of the hole 105 has moved down to the top of the substrate 101. Although the hole is shown with vertical walls, in actuality this is not the case. The top of the hole widens as the developer works its way down the hole, resulting in a tapered hole.

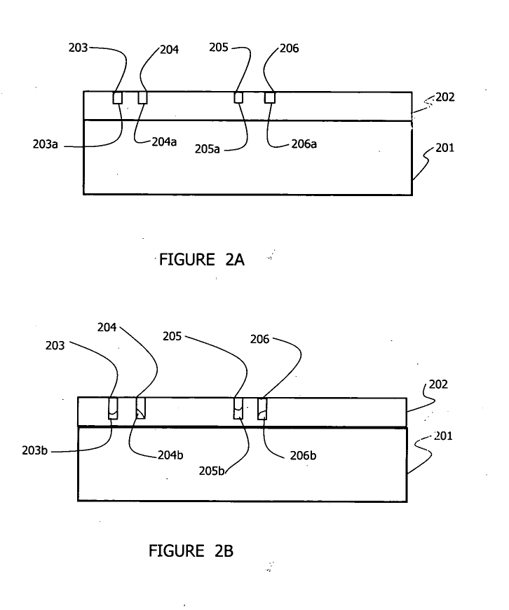

FIG. 2A illustrates a substrate 201 with a photoresist layer 202. The photoresist layer 202 is seen in the process of being developed and one can see a plurality of finer holes 203, 204, 205, 206 being developed in the photoresist layer. The bottoms 203a, 204a, 205a, 206a, of the finer holes 203, 204, 205, 206 are shown illustrating the progress of the process. With the increasingly smaller dimensions seen in modern devices, the holes being developed are becoming smaller and smaller. The current photoresist process of using a liquid solution developer cannot in all cases develop holes with these small features. A first problem is the surface tension of the liquid with regard to the dimensions of the holes. As seen in FIG. 2B, the liquid may not penetrate into the hole due to the small size of the hole. Areas 203b, 204b, 205b, 206b may exist where the developer has been unable to penetrate and thus there is not development, or sufficient development, of some features.

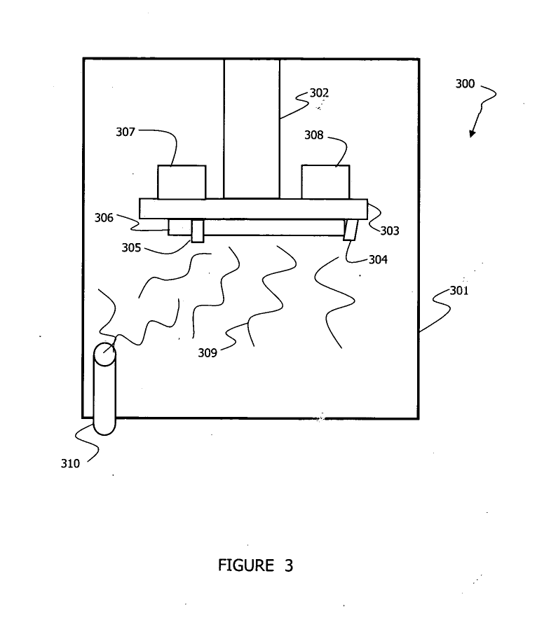

FIG. 3 is a sketch of an apparatus 300 according to some embodiments of the present invention. The apparatus 300 utilizes a vaporized developer which condenses on the surface of the photoresist layer to develop the layer. The vapor is able to penetrate features that a liquid developer may not be able to penetrate, and also allows the user to realize significant chemical cost savings. A substrate 306 is mounted onto a thermally controllable fixture 303. The substrate 306 may be attached to the fixture using mounting clips 304, 305, which may be three clips equally spread around a circular substrate in some embodiments. In some embodiments, the thermally controllable fixture 303 may have cooling tubes within it that cool the fixture by the circulation within the fixture of a cooled liquid. The thermally controllable fixture 303 may be mounted to a fixture arm 302 which is in turn fixed to a chamber 301 within which the fixture arm resides.

A developer inlet 310 delivers a vaporized developer mixture 309 into the chamber 301. In some embodiments, there may be a plurality of developer inlets, and different constituents of the vapor may be supplied via different inlets. In some embodiments, the developer is mixed prior to its introduction into the chamber. The vaporized developer mixture 309 condenses on the substrate 306, which in the configuration seen in FIG. 3 will have its photoresist layer facing downwards and therefore fully exposed to the vaporized developer mixture. In some embodiments, the substrate 306 will be cooled by the thermally controllable fixture 303, which will facilitate the condensation of the vaporized developer mixture 309 onto the photoresist layer. In this fashion, the vapor will penetrate the features forming as the development process goes along in a much more effective manner than with liquid developer solution, especially in the case of very small features. In some embodiments, the photoresist layer may not be horizontal and facing downwards, but may be in a different position.

In some embodiments, one or more ultrasonic vibrators 307, 308 may be mounted onto the back of the thermally controllable fixture 303, or another location adapted to provide vibration to the substrate 306. The vibration delivered by the ultrasonic vibrators 307, 308 may assist in removing the condensed developer from the holes as it builds up allowing the repeated penetration of vapor up into the bottom of the developing holes. In some embodiments, just one, or another number of vibrators may used. In some embodiments, a single frequency vibrator may be used. In some embodiments, variable frequency vibrators may be used.

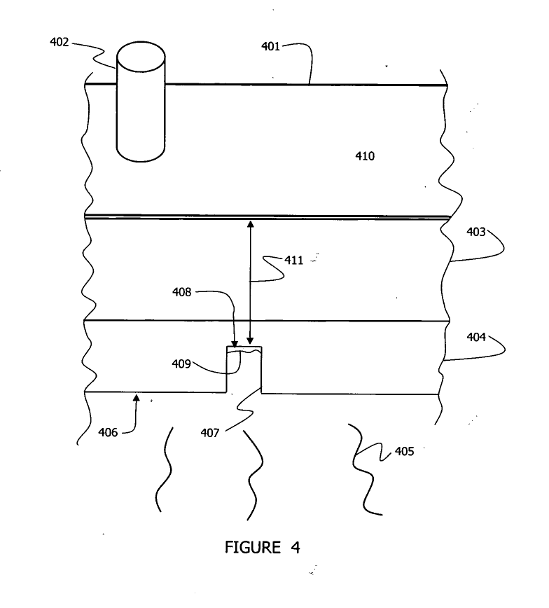

FIG. 4 is a sketch of a section of the substrate and mounting fixture according to some embodiments of the present invention. A substrate 403 is shown with a photoresist layer 404. The substrate is mounted to a thermally controllable fixture 401. In some embodiments, coolant conduits 402 are routed into the thermally controllable fixture 401. The substrate 403 is mounted on its back surface 410 to the thermally controllable fixture 410. The photoresist layer 404 is cooled via conductive cooling through 411 the substrate 403.

The vaporized developer mixture 405 condenses on the surface 406 of the photoresist layer 404, and is also seen condensing 409 on the bottom 408 of the hole 407. As the hole 4057 deepens, the bottom 408 of the hole 407 should be colder than the surface 406 of the photoresist layer 404, as the conductive path is longer to the cooled mounting fixture. Although FIG. 4 illustrates the case wherein the photoresist layer is horizontal and facing downwards, other physical positions may be used. For example, positions between the vertical and the horizontal plane may be used.

In some embodiments of the present invention, the vaporized developer mixture is comprised of gaseous ammonia, steam, and gaseous hexamethyldisalizane.(HMDS), and also a neutral gas such as nitrogen. The gaseous ammonia and the steam can condense at the surface creating ammonium hydroxide. Because of the possibility of a fast attack on the photoresist layer resulting in cracking of the unexposed portion of the photoresist layer, the HMDS is used as a moderator to minimize this cracking problem. This can be considered Hexamethyl Ammonium Hydroxide (HMAH) development.

An exemplary process according to some embodiments of the present invention uses the vaporized developer mixture at 100 C. The mixture is comprised approximately equally of nitrogen, ammonia, steam, and HMDS. A exemplary pressure would be 200-600 Torr, and the process would be run at 1 to 2.5 minutes. A substrate is mounted onto a thermally controllable fixture in a chamber. The chamber is sealed and the substrate is cooled, or may be maintained at room temperature. The vaporized developer mixture is delivered to the chamber. A return system may remove the liquefied vapor from the chamber during the process in some embodiments.

Significant process cost savings may be realized when practicing the process according to embodiments of the present invention. For example, current processes do not efficiently develop to the bottom of features. Typically, the substrate is hard baked and the plasma descummed after photoresist development. With the efficient development according to embodiments of the present invention, some or all of these post-development processes can be eliminated. In addition, there is potentially and quite practically an order of magnitude savings in chemical cost compared to current wet developing methods. Using illustrative costs comparisons, a typical wet development process may cost 5 dollars per process. And a wafer may have 20 photoresist development cycles during its overall processing. The cost of vapor chemical per wafer may fall in to the 10 cents per process range. Savings may be in the range of 98 dollars per wafer.

As evident from the above description a wide variety of embodiments may be configured from the description given herein and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general invention.

I claim:

1. A method for the developing of photoresist comprising:
mounting a substrate in a process chamber;
delivering a vaporous mixture of photoresist developer to said chamber.

2. The method of claim 1 wherein mounting a substrate comprises mounting the substrate onto a thermally controllable fixture.

3. The method of claim 1 wherein said substrate comprises a photoresist layer at least partially on an outermost surface of said substrate.

4. The method of claim 3 wherein said surface faces predominantly downward.

5. The method of claim 3 further comprising cooling the substrate.

6. The method of claim 5 wherein cooling the substrate comprises cooling the substrate using the thermally controllable fixture.

7. The method of claim 5 further comprising vibrating the substrate.

8. The method of claim 3 further comprising vibrating the substrate.

9. The method of claim 1 wherein said vaporous mixture of photoresist comprises:
ammonia; and
steam.

10. The method of claim 9 wherein said vaporous mixture of photoresist further comprises Hexamethyldisalizane.

11. The method of claim 10 wherein said vaporous mixture of photoresist further comprises an inert gas.

12. The method of claim 11 wherein said inert gas comprises nitrogen.

13. The method of claim 5 wherein said vaporous mixture of photoresist comprises:
ammonia; and
steam.

14. The method of claim 13 wherein said vaporous mixture of photoresist further comprises Hexamethyldisalizane.

15. The method of claim 14 wherein said vaporous mixture of photoresist further comprises an inert gas.

16. An apparatus comprising:
a process chamber;
an inlet for the delivery of vapor to said process chamber;
a thermally controllable mounting fixture; and
a vibrator, said vibrator adapted to vibrate the thermally controllable mounting fixture.

17. The apparatus of claim 16 wherein said vapor comprises:
ammonia; and
steam.

18. The apparatus of claim 17 wherein said vapor further comprises Hexamethyldisalizane.

19. An apparatus comprising:
a process chamber;
an inlet for the delivery of vapor to said process chamber;
a thermally controllable mounting fixture; and
wherein said vapor comprises:
ammonia; and
steam.

20. The apparatus of claim 19 wherein said vapor further comprises Hexamethyldisalizane.
